(19) United States
(12) Patent Application Publication
(10) Pub. No.: US 2002/0069678 A1
(43) Pub. Date: Jun. 13, 2002

(54) METHOD AND APPARATUS FOR PRODUCING BASALTIC FIBERS

(76) Inventor: LJUDMILA GRIGORIEVNA ASLANOVA, MOSCOW (RU)

Correspondence Address: SMITH GAMBRELL & RUSSELL LLP, BEVERIDGE DEGRANDI WEILACHER & YOUNG, INTELLECTUAL PROPERTY GROUP, 1850 M STREET N W SUITE 800, WASHINGTON, DC, 20036

(21) Appl. No.: 09/314,001

(22) Filed: May 19, 1999

Related U.S. Application Data
(63) Continuation of application No. PCT/RU97/00355, filed on Nov. 18, 1997.

(30) Foreign Application Priority Data
Nov. 19, 1996 (RU) 96122192
Nov. 18, 1997 (RU) PCTRU9700355

(51) Int. Cl. C03B 37/02

(52) U.S. Cl. 65/475; 65/474

(57) ABSTRACT

Mineral fibers made of natural basalt materials are produced by preheating basalt to a temperature of between 150 and 900° C., loading the preheated basalt into a melting furnace, melting the basalt to form a glass mass, moving the melted glass mass through a stabilization zone of the melting furnace until a fiber production temperature of t^{melt}+(50-250° C.) is reached, further stabilizing the glass mass in a feeder at a temperature of 1250 to 1450° C. to obtain a glass mass having the composition

$$\frac{{Al}_{2} {O}_{3} + {SiO}_{2}}{CaO + MgO} \geq 3 \frac{FeO}{{Fe}_{2} {O}_{3}} \geq 0.5$$

$$\frac{2 {Al}_{2} {O}_{3} + SiO2}{2 {Fe}_{2} {0}_{3} + FeO + CaO + MgO + {K}_{2} O + {Na}_{2} O} > 0.5$$

The further stabilized glass mass is introduced to a feeding unit, and the fibers are drawn through dies, oiled, and wound onto reels. The apparatus includes a melting furnace and a basalt dosing unit which includes a heat exchanger connected to the firebox of the furnace. The furnace has a firing space where the basalt is melted to form a glass mass, and a stabilization zone where the mass glass is stabilized. A feeder receives molten glass from the stabilization zone and supplies the glass to dies from which the fibers are drawn. Mechanisms are provided for lubricating the fibers and winding them onto reels. The invention shortens the industrial cycle and increases the fiber resistance and thermal endurance.

### FIELD OF THE INVENTION

The present invention relates to a method and apparatus for manufacturing mineral fibers from natural materials of the basalt group (basalts, andesitobasalts, andesites, gabbro etc.) which can be used in the construction, textile and chemical industries.

### REFERENCE TO RELATED APPLICATION

This is a continuation of International Application PCT/RU97/00355 filed under the Patent Cooperation Treaty on Nov. 18, 1997, the entirety of which is incorporated by reference into this specification.

### BACKGROUND OF THE INVENTION

There are three main types of rock composition of the basalt group. The first type: rock composition enriched with oxides of iron and titanium (˜70% of Fe₂O₃ and 20% of TiO₂). The second type: basalt rocks enriched with oxides of aluminum and silicon (˜±25% of Al₂O₃ and 55% of SiO₂). The third type: basalt rocks enriched with oxides of magnesium, calcium and iron (˜12% of MgO, 20% of CaO, 10% of Fe₂O₃).

All these compositions are intended for basaltic fiber manufacture. However, to obtain temperature and chemical resistant fiber of high quality, the basalt rock composition is limited by the content of oxides. For example, in order to produce basaltic fibers, a glass is known containing the oxides SiO₂, Al₂O_{3,} Fe₂O₃, TiO₂FeO, MnO, CaO, MgO, K₂O, Na₂O, SO₃, P₂O₅, Se₂O₃, ZnO with the relations of constituents Al₂O₃/CaO+MgO <2.0, ensuring increased acid resistance and temperature range of manufacture (Russian patent 2039019, class CO3C13/02, 1995).

However the known composition of glass makes it possible to obtain high content of Al₂O₃ only in the specified range. This limits the use of basalts of other types and with other relations of oxides, and it eliminates the possibility of manufacturing from them a good acid and alkali resistant fiber of high heat stability.

The fiber manufacture from a glass mass of each individual composition requires certain production know-how. The closest method to the proposed one in its technical essence and the obtained result is a method for producing basaltic fibers which includes charging, melting of basalt in the interior of a furnace, feeding the melt into a feeder and stabilizing the glass mass, manufacture of fiber through a feeding unit, pulling the fiber through spinnerets, oiling the fiber, and reeling the fiber onto bobbins (Russian patent 2039715, class CO3B37/02, 1995).

The closest device to the proposed one is a device for producing basaltic fibers which includes a basalt weigher, a melting furnace, a feeder with discharging devices, feeding units, spinnerets, mechanisms for applying oil, and mechanisms for reeling the fibers up onto bobbins (Russian patent 2039715, class CO3B37/02,1995).

Disadvantages of the known method and device are: not very high quality of the fiber at a low percent of manufacture, the complexity of the production process because of the necessity of the preparation of basalt rock, the necessity of a high temperature range in the melting furnace, and a long cycle of glass mass stabilization that involves the possibility of its crystallization and hence the vitrification on the surface of spinnerets.

### SUMMARY OF THE INVENTION

An object of the invention is to provide a method and a device for obtaining corrosion resistant, heat stable continuous fibers out of basalt rocks of numerous compositions and to simplify the technology and the apparatus for manufacturing such fibers.

The technical result of the realization of the proposed method and device is to widen the technical possibilities of using basalt rocks of a wide range with a reduced process cycle, to increase the stability of the process, and to improve the strength, corrosion resistance and heat stability of the fiber.

The technical result is obtained in a method for producing basaltic fibers which includes the steps of preheating the basalt, charging the preheated basalt into a melting furnace, melting the basalt to form a glass mass, keeping the melted glass mass in a stabilizing section of the melting furnace until it reaches the fiber manufacture temperature, further stabilizing the glass mass in a feeder, pulling the fiber from spinnerets, oiling the fiber, and reeling it up onto bobbins. Stabilization in the feeder is carried out to obtain a glass mass composition with the relation of basic constituents

$$\frac{{Al}_{2} {O}_{3} + {SiO}_{2}}{CaO + MgO} \geq 3 \frac{FeO}{{Fe}_{2} {O}_{3}} \geq 0.5$$

$$\frac{2 {Al}_{2} {O}_{3} + SiO2}{2 {Fe}_{2} {0}_{3} + FeO + CaO + MgO + {K}_{2} O + {Na}_{2} O} > 0.5 .$$

The technical result is best attained when:

before charging into the furnace, the basalt is heated to 150-900° C.;

the fiber manufacture temperature is maintained equal to t^{melt}+(50-250° C.) where t^{melt} is a temperature range of basalt melting;

stabilizing of the glass mass in the feeder is carried out at a temperature of 1250-1450° C.

The technical result is obtained in a device for producing basaltic fibers, which includes a basalt weigher, a melting furnace, a feeder with discharging devices, feeding units, spinnerets, mechanisms for applying oil, and mechanisms for reeling the fibers up onto bobbins. According to the invention, a heat exchanger connects the basalt weigher with a firing space of the melting furnace, and the melting furnace has a stabilizing section for stabilizing the melted glass mass. The stabilizing section is connected with the feeder. The best technical result is attained when the height of the stabilizing section is 0.4-0.6 of the height of the inner space of the furnace. A heat exchanger preliminarily heats the basalt before it is charged into the furnace. The glass mass is stabilized to obtain glass mass composition with the relation of basic constituents

$$\frac{{Al}_{2} {O}_{3} + {SiO}_{2}}{CaO + MgO} \geq 3 \frac{FeO}{{Fe}_{2} {O}_{3}} \geq 0.5$$

$$\frac{2 {Al}_{2} {O}_{3} + SiO2}{2 {Fe}_{2} {0}_{3} + FeO + CaO + MgO + {K}_{2} O + {Na}_{2} O} > 0.5 ,$$

making it possible to remove crystal water, gas bubbles and foam, to stabilize the volume of the glass mass to obtain an even and smooth surface, and to ensure the stability of the temperature range and viscosity which is essential for fiber manufacture. The presence of a heat exchanger in the weigher on simultaneous charging ensures uniform heating throughout the volume of basalt by the reduction of hot air flowing from the firing space of the melting furnace, enabling the utilization of waste gases and the reduction of fuel consumption. The stabilizing section which has a height of 0.4-0.6 of the height of the furnace interior space contributes to stabilizing the melt in volume at the furnace exit with a specified temperature. The stabilizing section height is determined by the melt height as the temperature decreases, and the possible exit of gases and foam.

The invention utilizes new combinations of technical features which satisfy the “novelty” and “inventive step”criteria. The utilization of the invention serves to increase the productivity of the melting furnace, and simultaneously decrease fuel and power consumption. This fact establishes that the proposed method and device satisfy the “industrial applicability”criterion.

### BRIEF DESCRIPTION OF THE DRAWINGS

FIG. 1 illustrates an apparatus for producing basaltic fibers, using the process of the invention.

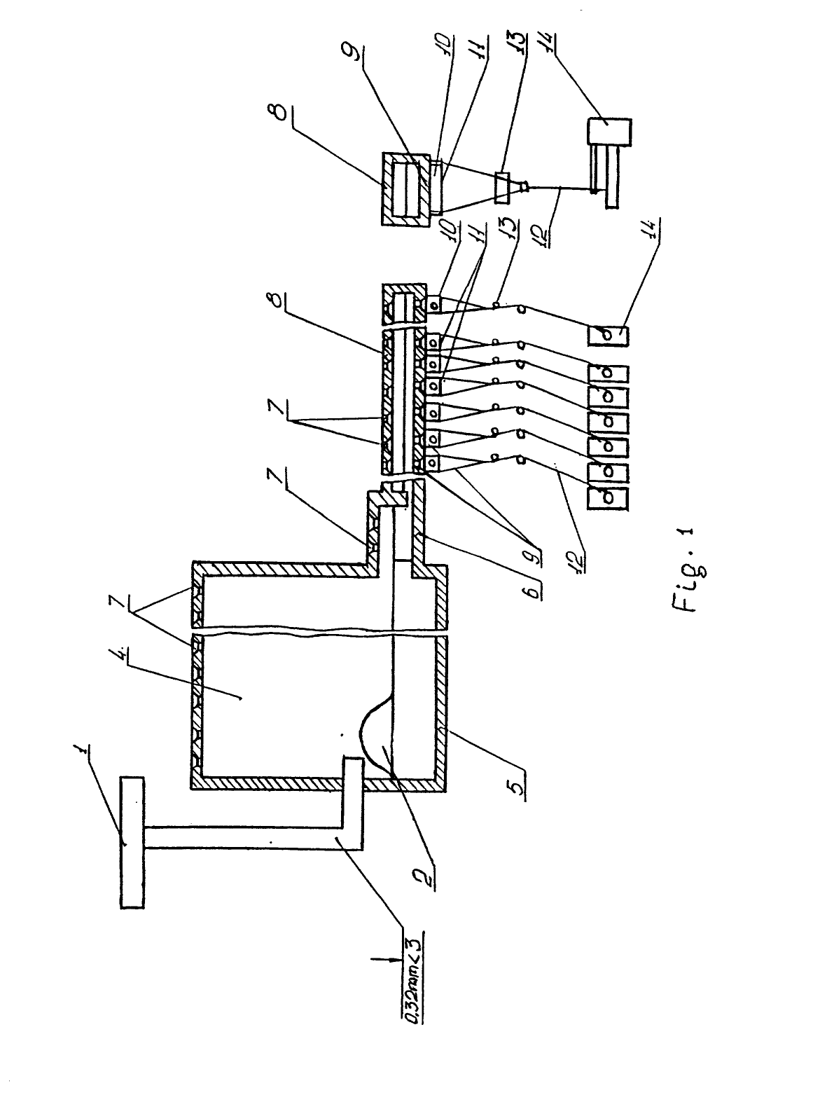

### DETAILED DESCRIPTION

The apparatus is a plant, which has a weigher 1 for basalt 2 charging and a heat exchanger 3, connected with a firing space 4 of the melting furnace 5. The melting furnace 5 has a stabilizing section 6 in which the melted glass mass becomes stable in volume when reaching the temperature of fiber manufacture. The melting furnace 5 and stabilizing section 6 have heating systems 7. The stabilizing section 6 of the melting furnace 5 is connected to a feeder 8 where the melt becomes stable till averaging the mass and ensuring the relation of constituents in the composition. The feeder 8 has discharging devices 9 and feeding units 10 delivering the melt into spinnerets 11 through which the basaltic fibers 12 are pulled. Then the fibers 12 are supplied to oiling mechanisms 13 and mechanisms 14 for reeling the fibers onto bobbins.

The basalt compositions used in practicing the invention are given in Tables 1-4.

According to the method, basalt rocks are first cleansed of impurities, powdered, and delivered through the weigher 1 into the melting furnace 5. The weigher 1 is connected with a heat exchanger 3 where basalts 2 are heated to a temperature 150-900° C. by hot air coming from the firing space 4 of the furnace 5. The heated basalts 2 enter the melting furnace 5 where they melt at a temperature of 1450° C.±50° C. until a glass mass melt is formed. Then the glass mass melt enters the stabilizing section 6 of the melting furnace 5. The limited height of the stabilizing section 6 ensures the stabilization and temperature reduction to a temperature of fiber manufactures which is t^{melt}+(50-250° C.). In the stabilizing section 6, gas bubbles and foam are expelled and the surface becomes smooth and even. The melting furnace 5 and its stabilizing section 6 have heating systems 7. Out of the stabilizing section 6, a partially stabilized melt of glass mass enters the feeder 8 for averaging and obtaining the composition necessary for fiber manufacture. The feeder 8 also has heating systems 7 to maintain a temperature range of fiber manufacture (1350-1450° C.) and a viscosity of 60-240 Pa/s.

Example of glass mass compositions and production process conditions of fiber manufacture are presented in Table 5 and 6.

Out of the feeder (8) the melt of glass mass is delivered by a stream feeding unit(9), through feeding units (10) to spinnerets (11). Elementary threads of the fiber (12) are pulled from the spinnerets, oiled by mechanisms (13), and reeled up onto bobbins (14).

Physico-mechanical properties of the basalt fibers are shown in Table 7.

As will be seen from the Table 7, the method and apparatus according to the invention make it possible to obtain high-strength, corrosion resistant, heat stable continuous fiber out of basalt rocks of numerous compositions, and to simplify the technology of its manufacture.

TABLE 1

| Compo- | | | | | | | | | | |
|---|---|---|---|---|---|---|---|---|---|---|
| sition | Composition of rock base | | | | | | | | | |
| number | Na | Mg | Al | Si | K | Ca | Ti | Mn | Fe | P |
| 1. | 4.567 | 0.232 | 11.537 | 32.932 | 2.426 | 1.428 | 12.771 | 0.240 | 33.968 | — |
| 2. | 0.415 | 13.552 | 1.153 | 51.318 | 0.184 | 21.752 | 1.320 | 0.309 | 9.999 | — |
| 3. | 6.573 | 0.358 | 20.340 | 60.648 | 4.873 | 2.088 | 1.506 | 0.001 | 2.689 | 0.326 |
| 4. | 3.513 | 4.067 | 11.235 | 44.778 | 2.670 | 7.883 | 5.325 | 0.474 | 19.651 | 0.454 |
| 5. | 5.744 | 0.465 | 19.541 | 56.221 | 4.503 | 3.924 | 2.889 | 0.180 | 5.642 | 0.890 |

TABLE 2

| Compo- | | | | | | | | | | |
|---|---|---|---|---|---|---|---|---|---|---|
| sition | Composition of large inclusions | | | | | | | | | |
| number | Na | Mg | Al | Si | K | Ca | Ti | Mn | Fe | P |
| 1. | 5.420 | 0.352 | 26.824 | 54.104 | 0.461 | 10.875 | 0.330 | 0.061 | 1.552 | 0.00 |
| 2. | 6.672 | 0.000 | 20.207 | 64.108 | 6.410 | 1.540 | 0.300 | 0.024 | 0.489 | 0.248 |
| 3. | 1.425 | 13.499 | 2.304 | 50.003 | 0.166 | 19.882 | 1.917 | 0.216 | 10.279 | 0.871 |
| 4. | 0.984 | 0.685 | 24.053 | 56.550 | 4.568 | 8.310 | 2.847 | 0.031 | 1.992 | 0.00 |
| 5. | 4.160 | 1.859 | 17.890 | 58.470 | 4.688 | 5.817 | 0.497 | 0.245 | 6.378 | 0.00 |

TABLE 3

| Compo- | | | | | | | | | | |
|---|---|---|---|---|---|---|---|---|---|---|
| sition | Composition of small inclusions | | | | | | | | | |
| number | Na | Mg | Al | Si | K | Ca | Ti | Mn | Fe | P |
| 1. | 5.775 | 0.413 | 18.112 | 63.813 | 8.139 | 1.459 | 0.132 | 0.000 | 2.156 | 0.000 |
| 2. | 11.614 | 2.263 | 22.164 | 55.601 | 0.260 | 2.243 | 0.159 | 0.098 | 3.819 | 1.776 |
| 3. | 0.422 | 1.364 | 0.817 | 0.830 | 0.086 | 0.214 | 23.541 | 1.226 | 71.502 | 0.000 |
| 4. | 0.371 | 2.138 | 1.035 | 0.627 | 0.095 | 0.060 | 20.530 | 0.796 | 72.217 | 0.134 |
| 5. | 0.727 | 12.683 | 1.364 | 49.475 | 0.187 | 20.085 | 2.023 | 0.250 | 13.121 | 0.087 |

TABLE 4

| Compo- | | | | | | | | | | |
|---|---|---|---|---|---|---|---|---|---|---|
| sition | Average composition of starting basalt | | | | | | | | | |
| number | Na | Mg | Al | Si | K | Ca | Ti | Mn | Fe | P |
| 1. | 6.325 | 1.970 | 17.833 | 55.903 | 4.553 | 4.672 | 1.532 | 0.160 | 6.977 | 0.000 |
| 2. | 5.058 | 7.932 | 14.127 | 46.164 | 2.320 | 4.697 | 1.343 | 0.396 | 16.461 | 1.512 |
| 3. | 5.877 | 2.773 | 17.493 | 53.716 | 8.923 | 4.867 | 1.299 | 0.098 | 8.276 | 1.680 |
| 4. | 4.587 | 3.187 | 17.660 | 52.501 | 3.927 | 5.515 | 1.701 | 0.155 | 8.541 | 1.953 |
| 5. | 4.404 | 3.470 | 16.824 | 51.606 | 2.810 | 7.681 | 1.852 | 0.185 | 9.223 | 2.944 |

TABLE 5

| Compo- | | | | | | | | | | | | | |
|---|---|---|---|---|---|---|---|---|---|---|---|---|---|
| sition | Glass mass composition of fibre pulling | | | | | | | | | | Al₂O₃ | | 2Al₂O₃ + |
| number | Na | Mg | Al | Si | K | Ca | Ti | Mn | Fe | P | + SiO₂ | FeO | SiO₂ |
| | | | | | | | | | | | CaO + | Fe₂O₃ | 2Fe₂O₃ + |
| | | | | | | | | | | | MgO | | + FeO + |
| | | | | | | | | | | | | | + CaO + |
| | | | | | | | | | | | | | + MgO + |
| | | | | | | | | | | | | | + K₂O + |
| | | | | | | | | | | | | | + Na₂O |
| 1. | 2.00 | 10.58 | 11.82 | 50.42 | 0.52 | 8.84 | 1.04 | 8.18 | 12.25 | 0.21 | 3.2 | 3.34 | 2.0 |
| 2. | 2.34 | 5.47 | 12.58 | 49.03 | 0.66 | 9.53 | 2.85 | 0.32 | 14.03 | 0.30 | 4.11 | 2.62 | 2.06 |
| 3. | 3.88 | 4.65 | 16.75 | 50.61 | 1.0 | 9.07 | 1.81 | 0.18 | 10.26 | 0.40 | 4.9 | 0.54 | 2.37 |
| 4. | 2.93 | 5.99 | 14.89 | 50.15 | 0.34 | 3.82 | 2.04 | 0.22 | 12.05 | 1.98 | 4.38 | 1.52 | 2.37 |
| 5. | 4.75 | 3.54 | 15.33 | 49.66 | 3.10 | 6.56 | 2.84 | 0.21 | 12.05 | 1.98 | 6.44 | 1.62 | 2.39 |

TABLE 6

| | Point of | | | |
|---|---|---|---|---|
| | crys- | | Heat range | Viscosity |
| | tallization | | of fibre | range |
| Composition | upon limit | Fibre diametre | manufacture | at T_{fmhr} |
| number | T_{culp} ° C. | mcm | T_{fmhr} ° C. | PaC |
| 1. | 1290 | 8.4-12 | 1360-1400 | 104-62 |
| 2. | 1275 | 7.0-13 | 1380-1440 | 112-64 |
| 3. | 1240 | 7.0-11 | 1370-1450 | 188-64 |
| 4. | 1250 | 7.0-12 | 1350-1440 | 235-96 |
| 5. | 1245 | 7.0-12 | 1350-1430 | 235-104 |

TABLE 7

| | Strength and chemical resistance of fibre | | | | | |
|---|---|---|---|---|---|---|
| Compo- | | Tensile | Chemical resistance in % | | | |
| sition | Fibre diametre | strength | after three-hour boiling | | | |
| number | mcm | MPa | H₂O | NaOH | | HCl |
| | | | | 0.5H | 2H | 2H |
| 1. | 10.2 | 2400 | 99.3 | 92.6 | 85.3 | 75.9 |
| 2. | 10.0 | 3110 | 99.4 | 97.5 | 94.0 | 80.6 |
| 3. | 9.0 | 2240 | 99.5 | 98.2 | 95.2 | 91.0 |
| 4. | 9.5 | 3050 | 99.4 | 97.6 | 96.8 | 90.1 |
| 5. | 9.5 | 3100 | 99.4 | 94.1 | 92.5 | 83.5 |

I claim:

1. A method for producing basalt fibers, comprising the steps of:
preheating basalt;
charging the preheated basalt into a melting furnace;
heating the basalt in said furnace to form a glass mass;
stabilizing the glass mass in a stabilizing section of the melting furnace until it reaches a fiber manufacturing temperature;
introducing the stabilized glass mass into a feeder;
further stabilizing the glass mass in the feeder to obtain a glass mass having the composition
$$\frac{{Al}_{2} {O}_{3} + {SiO}_{2}}{CaO + MgO} \geq 3 \frac{FeO}{{Fe}_{2} {O}_{3}} \geq 0.5$$
$$\frac{2 {Al}_{2} {O}_{3} + SiO2}{2 {Fe}_{2} {0}_{3} + FeO + CaO + MgO + {K}_{2} O + {Na}_{2} O} > 0.5$$
forming fibers by pulling the further stabilized glass mass from spinnerets which receive glass from the feeder.

2. A method according to claim 1 wherein the preheating step heats the basalt to a temperature of 150-900° C.

3. A method according to claim 1 wherein the temperature of the glass mass from which the fibers are pulled is t^{melt}+(50-250° C.), where t^{melt} is the basalt melting temperature.

4. A method according to claim 3 wherein the preheating step heats the basalt to a temperature of 150-900° C.

5. A method according to claim 1, wherein the glass mass is stabilized in the feeder at a temperature of 1250-1450° C.

6. A method according to claim 5 wherein the preheating step heats the basalt to a temperature of 150-900° C.

7. A method according to claim 6 wherein the temperature of the glass mass from which the fibers are pulled is t^{melt}+(50-250° C.), where t^{melt} is the basalt melting temperature.

8. Apparatus for producing basaltic fibers, comprising
a basalt weigher;
a melting furnace having a firing space and a stabilizing section;
a heat exchanger connecting the basalt weigher to the firing space for preheating basalt which is charged into the melting furnace;
a feeder which receives molten glass from the melting furnace, said feeder being connected by the stabilizing section to the firing space;
spinnerets which receive molten glass from the feeder; and
mechanisms which pull fibers from the spinnerets.

9. Apparatus according to claim 8 wherein the stabilizing section has a height which is 0.4-0.6 of the height of the height of the firing space.

10. Apparatus according to claim 9 wherein the heat exchanger is operable to preheat the basalt to a temperature of 150-900° C.

11. Apparatus according to claim 9 including means for heating the glass mass from which the fibers are pulled to a temperature of t^{melt}+(50-250° C.), where t^{melt} is the basalt melting temperature.

12. Apparatus according to claim 9 including means for maintaining glass mass at a stabilizing temperature which is 1250-1450° C.

13. Apparatus according to claim 8 wherein the heat exchanger is operable to preheat the basalt to a temperature of 150-900° C.

14. Apparatus according to claim 13 including means for heating the glass mass from which the fibers are pulled to a temperature of t ^{melt}+(50-250° C.), where t ^{melt} is the basalt melting temperature.

15. Apparatus according to claim 13 including means for maintaining glass mass at a stabilizing temperature which is 1250-1450° C.

16. Apparatus according to claim 8 including means for heating the glass mass from which the fibers are pulled to a temperature of t^{melt}+(50-250° C.), where t^{melt} is the basalt melting temperature.

17. Apparatus according to claim 8 including means for maintaining glass mass at a stabilizing temperature which is 1250-1450° C.

18. Apparatus according to claim 17 including means for heating the glass mass from which the fibers are pulled to a temperature of t^{melt}+(50-250° C.), where t^{melt} is the basalt melting temperature
